(19) United States
(12) Patent Application Publication
(10) Pub. No.: US 2018/0152271 A1
(43) Pub. Date: May 31, 2018

(54) WIRELESS DEVICE AND METHOD FOR UPLINK TRANSMISSION USING ORTHOGONAL SPREADING CODE

(71) Applicant: LG ELECTRONICS INC., Seoul (KR)

(72) Inventors: Hyangsun YOU, Seoul (KR); Yunjung YI, Seoul (KR); Suckchel YANG, Seoul (KR); Hanbyul SEO, Seoul (KR)

(73) Assignee: LG ELECTRONICS INC., Seoul (KR)

(21) Appl. No.: 15/574,805

(22) PCT Filed: May 23, 2016
(86) PCT No.: PCT/KR2016/005421

§ 371 Date: Nov. 16, 2017

Related U.S. Application Data
(60) Provisional application No. 62/165,957, filed on May 23, 2015.
(60) Provisional application No. 62/167,876, filed on May 28, 2015.

(51) Int. Cl. H04L 5/00; H04W 72/04

(52) U.S. Cl. CPC H04L 5/0017; H04W 72/0413

(57) ABSTRACT

An embodiment of the present description provides a method for transmitting an uplink data channel in a wireless communication system. The method can comprise the steps of: repeatedly arranging, on a plurality of first OFDM symbols, a first data symbol among a plurality of data symbols comprised in an uplink data channel; repeatedly arranging, on a plurality of second OFDM symbols, a second data symbol among the plurality of data symbols comprised in the uplink data channel; applying a first element of an orthogonal spreading code with respect to the plurality of first OFDM symbols; applying a second element of the orthogonal spreading code with respect to the plurality of second OFDM symbols; and transmitting to a base station a first uplink subframe comprising the plurality of first OFDM symbols and the plurality of second OFDM symbols.

### BACKGROUND OF THE INVENTION

### Field of the Invention

The present invention relates to mobile communication.

### Related Art

3rd generation partnership project (3GPP) long term evolution (LTE) evolved from a universal mobile telecommunications system (UMTS) is introduced as the 3GPP release 8. The 3GPP LTE uses orthogonal frequency division multiple access (OFDMA) in a downlink, and uses single carrier-frequency division multiple access (SC-FDMA) in an uplink. The 3GPP LTE employs multiple input multiple output (MIMO) having up to four antennas.

As disclosed in 3GPP TS 36.211 V10.4.0 (2011-12) “Evolved Universal Terrestrial Radio Access (E-UTRA); Physical Channels and Modulation (Release 10)”, a physical channel of LTE may be classified into a downlink channel, i.e., a PDSCH (Physical Downlink Shared Channel) and a PDCCH (Physical Downlink Control Channel), and an uplink channel, i.e., a PUSCH (Physical Uplink Shared Channel) and a PUCCH (Physical Uplink Control Channel).

Meanwhile, in recent years, research into communication between devices or the device and a server without human interaction, that is, without human intervention, that is, machine-type communication (MTC) has been actively conducted. The MTC represents a concept in which not a terminal used by human but a machine performs communication by using the existing wireless communication network.

Since MTC has features different from communication of a normal UE, a service optimized to MTC may differ from a service optimized to human-to-human communication. In comparison with a current mobile network communication service, MTC can be characterized as a different market scenario, data communication, less costs and efforts, a potentially great number of MTC devices, wide service areas, low traffic for each MTC device, etc.

Meanwhile, it is considered to expand or increase the cell coverage of the base station for the MTC device. However, if the MTC device is located in the Coverage Extension (CE) or Coverage Enhancement (CE) region, the MTC device cannot correctly receive the downlink channel. For this reason, the base station may repeatedly transmit the same downlink channel on a plurality of subframes, and the MTC device may repeatedly transmit the same uplink channel on a plurality of subframes.

However, when the same data is repeatedly transmitted over a plurality of subframes, there is a limitation in that the number of MTC devices using resources or the amount of data that can be transmitted using the same resource during the same time is greatly reduced.

### SUMMARY OF THE INVENTION

Accordingly, one aspect of the present disclosure aims to provide a data transmission method using orthogonal spreading codes.

Another aspect of the present disclosure aims to provide a wireless device for performing a data transmission method using orthogonal spreading codes.

In one aspect of the present disclosure, there is provided a method for transmitting an uplink data channel in a wireless communication system, the method comprising: repeatedly arranging a first data symbol of a plurality of data symbols on a plurality of first OFDM symbols, wherein the plurality of data symbols constitutes the uplink data channel; repeatedly arranging a second data symbol of the plurality of data symbols on a plurality of second OFDM symbols; applying a first element of orthogonal spreading codes to the plurality of first OFDM symbols; applying a second element of the orthogonal spreading codes to the plurality of second OFDM symbols; and transmitting a first uplink subframe including the plurality of first and second OFDM symbols to a base station.

In one embodiment, the orthogonal spreading codes have a length corresponding to a number of groups of the OFDM symbols repeatedly arranged in the first uplink subframe.

In one embodiment, applying the first element comprises multiplying, by the first element, the first data symbol repeatedly arranged on the plurality of first OFDM symbols.

In one embodiment, applying the first element comprises multiplying, by the first element, a complex-valued symbol of the first data symbol transmitted using resource elements of the plurality of first OFDM symbols.

In one embodiment, a number of the first OFDM symbols corresponds to a number resulting from a division of a total number of OFDM symbols used for transmitting the uplink data channel in the first uplink subframe by a length of the orthogonal spreading codes.

In one embodiment, applying the first element includes determining indexes of the orthogonal spreading codes to be applied to the first uplink subframe based on a coverage enhancement level obtained by performing Radio Resource Management (RRM).

In one embodiment, applying the first element include determining indexes of the orthogonal spreading codes to be applied to the first uplink subframe based on a repetition level at which the first data symbol is repeatedly arranged on the first OFDM symbols.

In one embodiment, transmitting the first uplink subframe to the base station comprises: receiving a signal indicating stopping of transmission of the uplink data channel from the base station; and stopping the transmission of the uplink data channel only after all of OFDM symbols to which the same element of the orthogonal spreading codes is applied have been transmitted to the base station.

In another aspect of the present disclosure, there is provided a wireless device for transmitting an uplink data channel in a wireless communication system, the device comprising a radio frequency unit and a processor coupled to the unit, wherein the processor is configured for: repeatedly arranging a first data symbol of a plurality of data symbols on a plurality of first OFDM symbols, wherein the plurality of data symbols constitutes the uplink data channel; repeatedly arranging a second data symbol of the plurality of data symbols on a plurality of second OFDM symbols; applying a first element of orthogonal spreading codes to the plurality of first OFDM symbols; applying a second element of the orthogonal spreading codes to the plurality of second OFDM symbols; and controlling the unit to transmit a first uplink subframe including the plurality of first and second OFDM symbols to a base station.

According to one embodiment of the present disclosure, when the same data is repeatedly transmitted over a plurality of subframes, a plurality of wireless devices may multiplex data with the same resource and transmit the data using the same resource.

### BRIEF DESCRIPTION OF THE DRAWINGS

FIG. 1 is a wireless communication system.

FIG. 2 illustrates a structure of a radio frame according to FDD in 3GPP LTE.

FIG. 3 illustrates a structure of a downlink radio frame according to TDD in the 3GPP LTE.

FIG. 4 is an exemplary diagram illustrating a resource grid for one uplink or downlink slot in the 3GPP LTE.

FIG. 5 illustrates a structure of a downlink subframe in 3GPP LTE.

FIG. 6. illustrates a structure of an uplink subframe in 3GPP LTE.

FIG. 7 shows a signal processing process for transmission of the PUSCH.

FIG. 8 illustrates an example of comparison between a single carrier system and a carrier aggregation system.

FIG. 9 is an example of a subframe having an Enhanced PDCCH (EPDCCH).

FIGS. 10A and 10B show frame structures for synchronous signal transmission in a normal CP and an extended CP, respectively.

FIG. 11 illustrates an example of the machine type communication (MTC).

FIG. 12 illustrates an example of cell coverage extension or enhancement for an MTC UE.

FIG. 13 is a diagram illustrating an example of a bundle transmission.

FIGS. 14A and 14B are illustrations showing some examples of RV (Redundancy Version) of a bundle transmission.

FIG. 15 is a diagram illustrating an example in which the same precoding is applied while a plurality of subframes are transmitted.

FIGS. 16A and 16B illustrate examples of subbands in which an MTC UE operates.

FIG. 17 shows an example in which orthogonal spreading codes are applied according to a PUSCH transmission method 1.

FIG. 18 shows positions of the uplink, downlink, or special subframe in the TDD environment.

FIG. 19 shows an example in which orthogonal spreading codes are applied according to a PUSCH transmission method 2.

FIG. 20 is a flowchart illustrating a PUSCH transmission method using orthogonal spreading codes according to the present disclosure.

FIG. 21 is a block diagram illustrating a wireless communication system in which an embodiment of the present disclosure is implemented.

### DESCRIPTION OF EXEMPLARY EMBODIMENTS

Hereinafter, based on 3rd Generation Partnership Project (3GPP) long term evolution (LTE) or 3GPP LTE-advanced (LTE-A), the present invention will be applied. This is just an example, and the present invention may be applied to various wireless communication systems. Hereinafter, LTE includes LTE and/or LTE-A.

The technical terms used herein are used to merely describe specific embodiments and should not be construed as limiting the present invention. Further, the technical terms used herein should be, unless defined otherwise, interpreted as having meanings generally understood by those skilled in the art but not too broadly or too narrowly. Further, the technical terms used herein, which are determined not to exactly represent the spirit of the invention, should be replaced by or understood by such technical terms as being able to be exactly understood by those skilled in the art. Further, the general terms used herein should be interpreted in the context as defined in the dictionary, but not in an excessively narrowed manner.

The expression of the singular number in the present invention includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the present invention, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present invention.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present invention will be described in greater detail with reference to the accompanying drawings. In describing the present invention, for ease of understanding, the same reference numerals are used to denote the same components throughout the drawings, and repetitive description on the same components will be omitted. Detailed description on well-known arts which are determined to make the gist of the invention unclear will be omitted. The accompanying drawings are provided to merely make the spirit of the invention readily understood, but not should be intended to be limiting of the invention. It should be understood that the spirit of the invention may be expanded to its modifications, replacements or equivalents in addition to what is shown in the drawings.

As used herein, ‘base station’ generally refers to a fixed station that communicates with a wireless device and may be denoted by other terms such as eNB (evolved-NodeB), BTS (base transceiver system), or access point.

As used herein, ‘user equipment (UE)’ may be stationary or mobile, and may be denoted by other terms such as device, wireless device, terminal, MS (mobile station), UT (user terminal), SS (subscriber station), MT (mobile terminal) and etc.

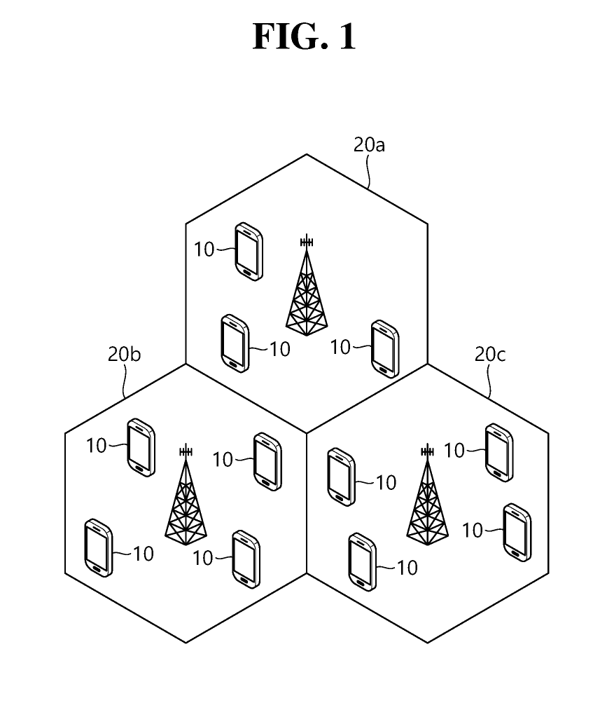

FIG. 1 illustrates a wireless communication system.

As seen with reference to FIG. 1, the wireless communication system includes at least one base station (BS) 20. Each base station 20 provides a communication service to specific geographical areas (generally, referred to as cells) 20a, 20b, and 20c. The cell can be further divided into a plurality of areas (sectors).

The UE generally belongs to one cell and the cell to which the UE belong is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the UE.

Hereinafter, a downlink means communication from the base station 20 to the UE1 10 and an uplink means communication from the UE 10 to the base station 20. In the downlink, a transmitter may be a part of the base station 20 and a receiver may be a part of the UE 10. In the uplink, the transmitter may be a part of the UE 10 and the receiver may be a part of the base station 20.

Meanwhile, the wireless communication system may be generally divided into a frequency division duplex (FDD) type and a time division duplex (TDD) type. According to the FDD type, uplink transmission and downlink transmission are achieved while occupying different frequency bands. According to the TDD type, the uplink transmission and the downlink transmission are achieved at different time while occupying the same frequency band. A channel response of the TDD type is substantially reciprocal. This means that a downlink channel response and an uplink channel response are approximately the same as each other in a given frequency area. Accordingly, in the TDD based wireless communication system, the downlink channel response may be acquired from the uplink channel response. In the TDD type, since an entire frequency band is time-divided in the uplink transmission and the downlink transmission, the downlink transmission by the base station and the uplink transmission by the terminal may not be performed simultaneously. In the TDD system in which the uplink transmission and the downlink transmission are divided by the unit of a subframe, the uplink transmission and the downlink transmission are performed in different subframes.

Hereinafter, the LTE system will be described in detail.

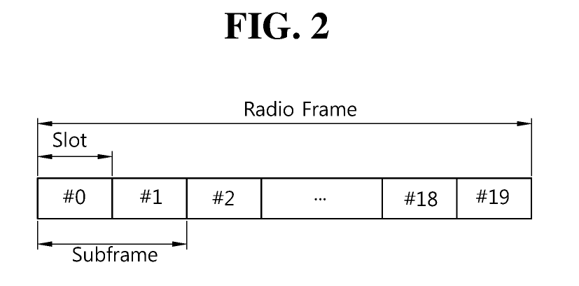

FIG. 2 shows a downlink radio frame structure according to FDD of 3rd generation partnership project (3GPP) long term evolution (LTE).

The radio frame of FIG. 2 may be found in the section 5 of 3GPP TS 36.211 V10.4.0 (2011-12) “Evolved Universal Terrestrial Radio Access (E-UTRA); Physical Channels and Modulation (Release 10)”.

The radio frame includes 10 sub-frames indexed 0 to 9. One sub-frame includes two consecutive slots. Accordingly, the radio frame includes 20 slots. The time taken for one sub-frame to be transmitted is denoted TTI (transmission time interval). For example, the length of one sub-frame may be 1 ms, and the length of one slot may be 0.5 ms.

The structure of the radio frame is for exemplary purposes only, and thus the number of sub-frames included in the radio frame or the number of slots included in the sub-frame may change variously.

Meanwhile, one slot may include a plurality of OFDM symbols. The number of OFDM symbols included in one slot may vary depending on a cyclic prefix (CP).

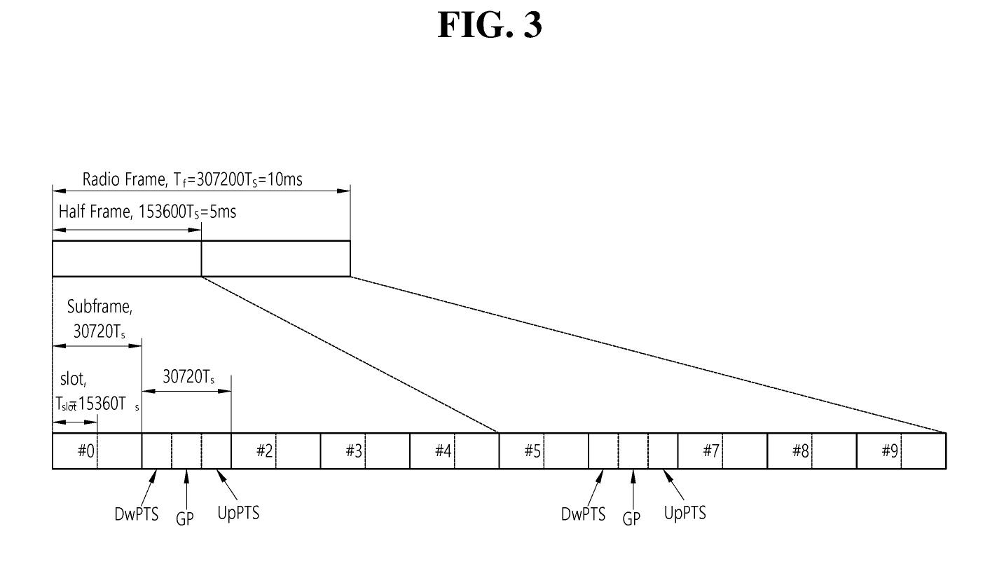

FIG. 3 illustrates the architecture of a downlink radio frame according to TDD in 3GPP LTE.

For this, 3GPP TS 36.211 V10.4.0 (2011-23) “Evolved Universal Terrestrial Radio Access (E-UTRA); Physical Channels and Modulation (Release 8)”, Ch. 4 may be referenced, and this is for TDD (time division duplex).

Sub-frames having index #1 and index #6 are denoted special sub-frames, and include a DwPTS (Downlink Pilot Time Slot: DwPTS), a GP (Guard Period) and an UpPTS (Uplink Pilot Time Slot). The DwPTS is used for initial cell search, synchronization, or channel estimation in a terminal. The UpPTS is used for channel estimation in the base station and for establishing uplink transmission sync of the terminal. The GP is a period for removing interference that arises on uplink due to a multi-path delay of a downlink signal between uplink and downlink.

In TDD, a DL (downlink) sub-frame and a UL (Uplink) co-exist in one radio frame. Table 1 shows an example of configuration of a radio frame.

TABLE 1

| UL-DL | Switch- | | | | | | | | | | | |
|---|---|---|---|---|---|---|---|---|---|---|---|---|
| config- | point | | Subframe index | | | | | | | | | |
| uration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

‘D’ denotes a DL sub-frame, ‘U’ a UL sub-frame, and ‘S’ a special sub-frame. When receiving a UL-DL configuration from the base station, the terminal may be aware of whether a sub-frame is a DL sub-frame or a UL sub-frame according to the configuration of the radio frame.

TABLE 2

| | Normal CP in downlink | | | Extended CP in downlink | | |
|---|---|---|---|---|---|---|
| | | UpPTS | | | UpPTS | |
| Special subframe | | Normal CP | Extended CP | | Normal CP | Extended CP |
| configuration | DwPTS | in uplink | in uplink | DwPTS | in uplink | in uplink |
| 0 | 6592*Ts | 2192*Ts | 2560*Ts | 7680*Ts | 2192*Ts | 2560*Ts |
| 1 | 19760*Ts | | | 20480*Ts | | |
| 2 | 21952*Ts | | | 23040*Ts | | |
| 3 | 24144*Ts | | | 25600*Ts | | |
| 4 | 26336*Ts | | | 7680*Ts | 4384*Ts | 5120*ts |
| 5 | 6592*Ts | 4384*Ts | 5120*ts | 20480*Ts | | |
| 6 | 19760*Ts | | | 23040*Ts | | |
| 7 | 21952*Ts | | | — | | |
| 8 | 24144*Ts | | | — | | |

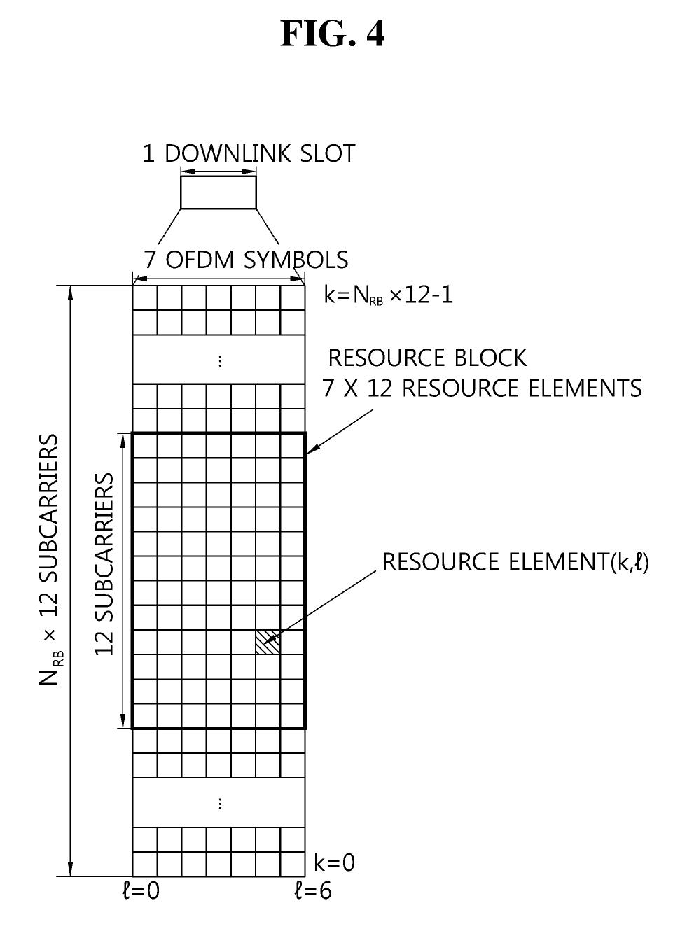

FIG. 4 illustrates an example resource grid for one uplink or downlink slot in 3GPP LTE.

Referring to FIG. 4, the uplink slot includes a plurality of OFDM (orthogonal frequency division multiplexing) symbols in the time domain and NRB resource blocks (RBs) in the frequency domain. For example, in the LTE system, the number of resource blocks (RBs), i.e., NRB, may be one from 6 to 110.

The resource block is a unit of resource allocation and includes a plurality of sub-carriers in the frequency domain. For example, if one slot includes seven OFDM symbols in the time domain and the resource block includes 12 sub-carriers in the frequency domain, one resource block may include 7×12 resource elements (REs).

Meanwhile, the number of sub-carriers in one OFDM symbol may be one of 128, 256, 512, 1024, 1536, and 2048.

In 3GPP LTE, the resource grid for one uplink slot shown in FIG. 4 may also apply to the resource grid for the downlink slot.

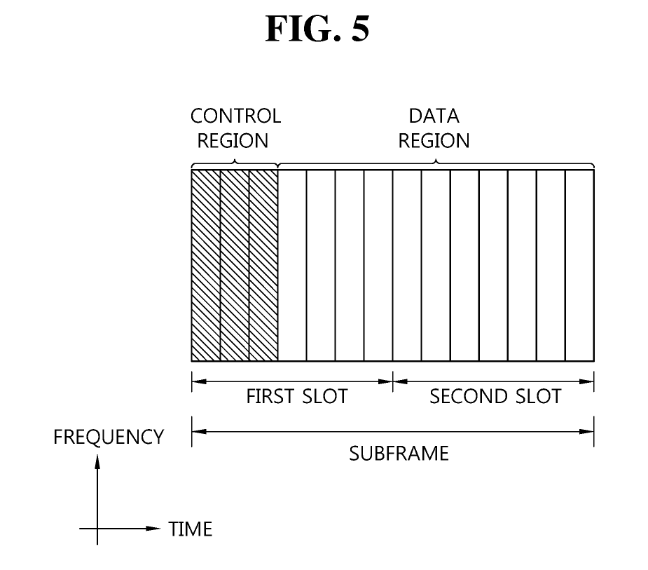

FIG. 5 illustrates the architecture of a downlink sub-frame.

In FIG. 5, assuming the normal CP, one slot includes seven OFDM symbols, by way of example.

The DL (downlink) sub-frame is split into a control region and a data region in the time domain. The control region includes up to first three OFDM symbols in the first slot of the sub-frame. However, the number of OFDM symbols included in the control region may be changed. A PDCCH (physical downlink control channel) and other control channels are assigned to the control region, and a PDSCH is assigned to the data region.

The physical channels in 3GPP LTE may be classified into data channels such as PDSCH (physical downlink shared channel) and PUSCH (physical uplink shared channel) and control channels such as PDCCH (physical downlink control channel), PCFICH (physical control format indicator channel), PHICH (physical hybrid-ARQ indicator channel) and PUCCH (physical uplink control channel).

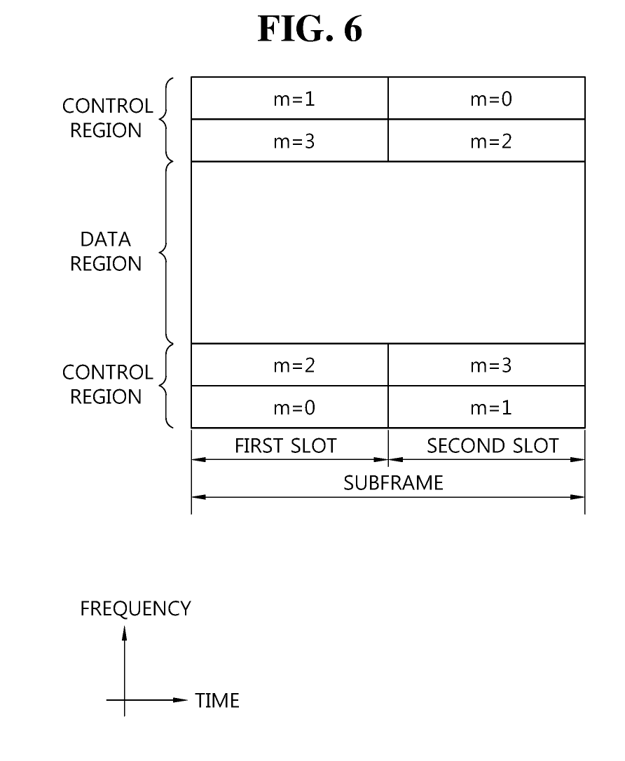

FIG. 6. illustrates a structure of an uplink subframe in 3GPP LTE.

Referring to FIG. 6, an uplink subframe may be divided into a control region and a data region in a frequency domain. The control region is allocated a PUCCH for transmission of uplink control information. The data region is allocated a PUSCH for transmission of data (along with control information in some cases).

A PUCCH for one UE is allocated a RB pair in a subframe. RBs in the RB pair take up different subcarriers in each of first and second slots. A frequency occupied by the RBs in the RB pair allocated to the PUCCH changes with respect to a slot boundary, which is described as the RB pair allocated to the PUCCH having been frequency-hopped on the slot boundary.

A UE transmits uplink control information through different subcarriers according to time, thereby obtaining a frequency diversity gain. m is a location index indicating the logical frequency-domain location of an RB pair allocated for a PUCCH in a subframe.

Uplink control information transmitted on a PUCCH may include a HARQ ACK/NACK, a channel quality indicator (CQI) indicating the state of a downlink channel, a scheduling request (SR) which is an uplink radio resource allocation request, or the like.

A PUSCH is mapped to a uplink shared channel (UL-SCH) as a transport channel. Uplink data transmitted on a PUSCH may be a transport block as a data block for a UL-SCH transmitted during a TTI. The transport block may be user information. Alternatively, the uplink data may be multiplexed data. The multiplexed data may be the transport block for the UL-SCH multiplexed with control information. For example, control information multiplexed with data may include a CQI, a precoding matrix indicator (PMI), an HARQ, a rank indicator (RI), or the like. Alternatively, the uplink data may include only control information.

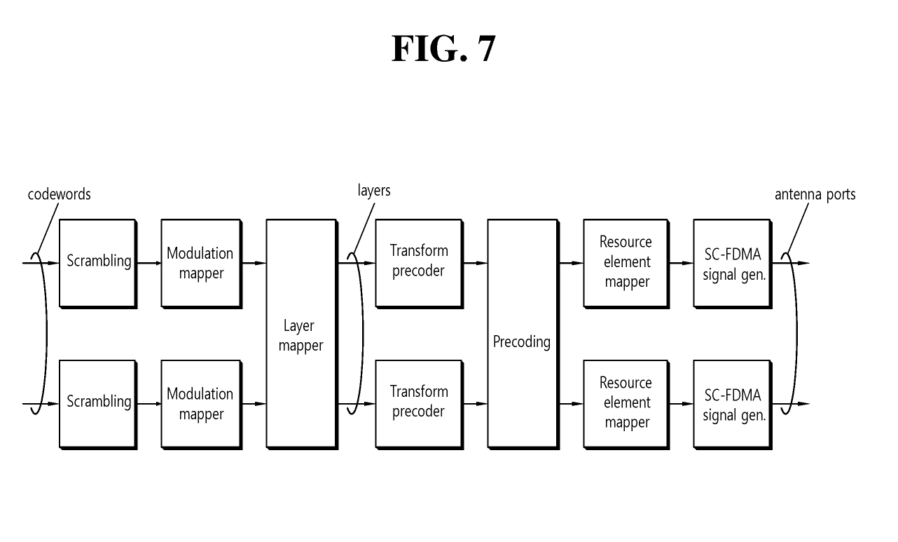

FIG. 7 shows a signal processing process for transmission of the PUSCH.

Referring to FIG. 7, a signal processing process for transmission of the PUSCH may employ a scrambling unit, a modulation mapper, a layer mapper, a transform precoder, a precoding unit, a resource element mapper and an SC-FDMA signal generation unit. The scrambling unit is configured to scramble the input codeword, that is, a block of b (0), . . . , and b(M_{bit}−1) bits. The modulation mapper maps a scrambled codeword to a modulation symbol representing a location on a signal constellation. The resource element mapper maps a symbol output from the precoding unit to a resource element.

Referring to FIG. 7, the input codeword, i.e. the block of b (0), . . . , and b(M_{bit}−1) bits is scrambled by the scrambling unit, and then is modulated by the modulation mapper, then is layer-mapped by the layer mapper, is precoded by the precoding unit, and then is element-mapped by the resource element mapper and is processed by the SC-FDMA signal generation unit to generate a SC-FDMA signal which in turn is transmitted through an antenna. The resource element mapper is configured to map the symbol output from the precoding unit to a resource element.

The scrambling sequence used for scrambling the PUSCH may be generated by the following equation.

c(n)=(x₁(n+N_{c})+x₂(n+N_{c}))mod 2

x₁(n+31)=(x₁(n+3)+x₁(n))mod 2

x₂(n+31)=(x₂(n+3)+x₂(n+2)+(n+1)+x₁(n))mod 2 [Equation 1]

In this connection, N_{C}=1600, x₁(i) refers to a first m-sequence, x₂(i) refers to a second m-sequence. A scrambling sequence generation unit may be initialized into Cᵢₙᵢₜ=510. The PUSCH may be modulated with quadrature phase shift keying (QPSK).

Hereinafter, a carrier aggregation system is now described.

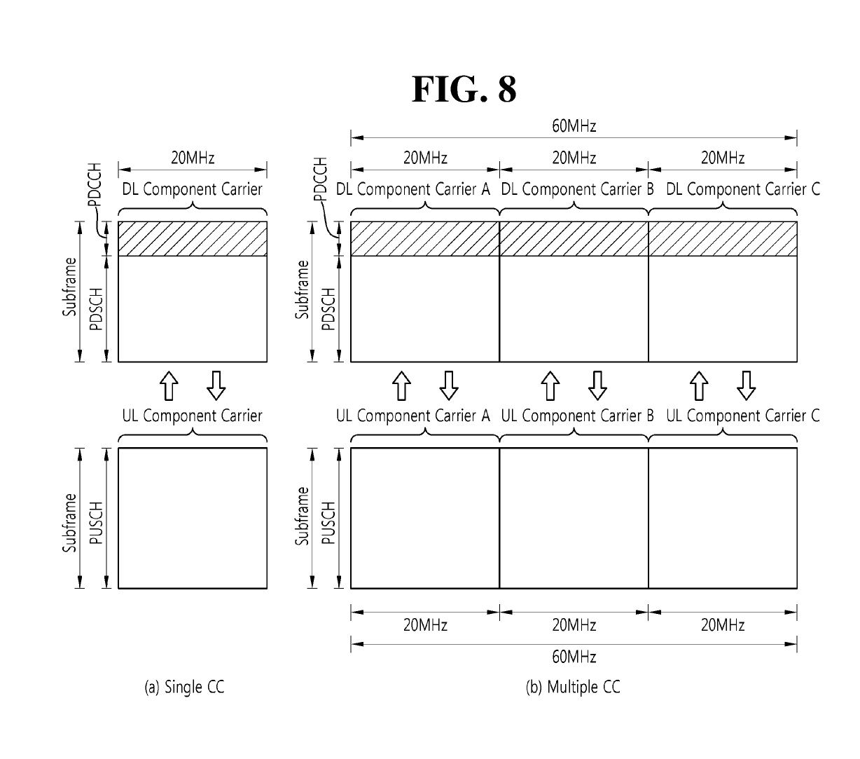

FIG. 8 illustrates an example of comparison between a single carrier system and a carrier aggregation system.

Referring to FIG. 8, there may be various carrier bandwidths, and one carrier is assigned to the terminal. On the contrary, in the carrier aggregation (CA) system, a plurality of component carriers (DL CC A to C, UL CC A to C) may be assigned to the terminal. Component carrier (CC) means the carrier used in then carrier aggregation system and may be briefly referred as carrier. For example, three 20 MHz component carriers may be assigned so as to allocate a 60 MHz bandwidth to the terminal.

Carrier aggregation systems may be classified into a contiguous carrier aggregation system in which aggregated carriers are contiguous and a non-contiguous carrier aggregation system in which aggregated carriers are spaced apart from each other. Hereinafter, when simply referring to a carrier aggregation system, it should be understood as including both the case where the component carrier is contiguous and the case where the control channel is non-contiguous.

When one or more component carriers are aggregated, the component carriers may use the bandwidth adopted in the existing system for backward compatibility with the existing system. For example, the 3GPP LTE system supports bandwidths of 1.4 MHz, 3 MHz, 5 MHz, 10 MHz, 15 MHz and 20 MHz, and the 3GPP LTE-A system may configure a broad band of 20 MHz or more only using the bandwidths of the 3GPP LTE system. Or, rather than using the bandwidths of the existing system, new bandwidths may be defined to configure a wide band.

The system frequency band of a wireless communication system is separated into a plurality of carrier frequencies. Here, the carrier frequency means the cell frequency of a cell. Hereinafter, the cell may mean a downlink frequency resource and an uplink frequency resource. Or, the cell may refer to a combination of a downlink frequency resource and an optional uplink frequency resource. Further, in the general case where carrier aggregation (CA) is not in consideration, one cell may always have a pair of an uplink frequency resource and a downlink frequency resource.

In order for packet data to be transmitted/received through a specific cell, the terminal should first complete a configuration on the specific cell. Here, the configuration means that reception of system information necessary for data transmission/reception on a cell is complete. For example, the configuration may include an overall process of receiving common physical layer parameters or MAC (media access control) layers necessary for data transmission and reception or parameters necessary for a specific operation in the RRC layer. A configuration-complete cell is in the state where, once when receiving information indicating packet data may be transmitted, packet transmission and reception may be immediately possible.

The cell that is in the configuration complete state may be left in an activation or deactivation state. Here, the “activation” means that data transmission or reception is being conducted or is in ready state. The terminal may monitor or receive a control channel (PDCCH) and a data channel (PDSCH) of the activated cell in order to identify resources (possibly frequency or time) assigned thereto.

The “deactivation” means that transmission or reception of traffic data is impossible while measurement or transmission/reception of minimal information is possible. The terminal may receive system information (SI) necessary for receiving packets from the deactivated cell. In contrast, the terminal does not monitor or receive a control channel (PDCCH) and data channel (PDSCH) of the deactivated cell in order to identify resources (probably frequency or time) assigned thereto.

Hereinafter, the Enhanced Physical Downlink Control Channel (EDPPCH) will be described.

The PDCCH is monitored in a limited region called a control region within a subframe. Further, for demodulation of the PDCCH, a CRS (Cell-Specific Reference Signal) transmitted in the entire band is used. As the kinds of control information are diversified and the amount of control information is increased, the flexibility of scheduling is degraded if only the legacy PDCCH is used. Further, EPDCCH (Enhanced PDCCH) is being introduced to reduce the burden of CRS transmission.

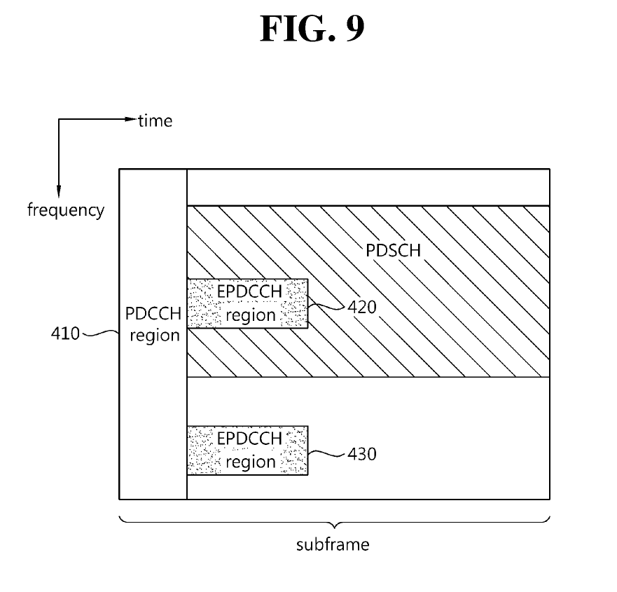

FIG. 9 is an example of a subframe having an EPDCCH.

The subframe may include zero or one PDCCH region 410 and zero or more EPDCCH regions 420 and 430.

The EPDCCH regions 420 and 430 are regions where the wireless device monitors the EPDCCH. The PDCCH region 410 is located within previous maximum 4 OFDM symbols of the subframe. The EPDCCH regions 420 and 430 may be flexibly scheduled in an OFDM symbol after the PDCCH region 410.

One or more EPDCCH regions 420 and 430 are set for the wireless device, and the wireless device may monitor the EPDCCH in the set EPDCCH regions 420 and 430.

The number/position/size of the EPDCCH regions 420 and 430 and/or the information on the subframe to be used for monitoring the EPDCCH may be informed to the wireless device via the RRC message or the like.

In the PDCCH region 410, the PDCCH may be demodulated based on the CRS. In the EPDCCH regions 420 and 430, a DM (demodulation) RS other than the CRS may be defined for demodulating the EPDCCH. The associated DM RS may be transmitted in the corresponding EPDCCH regions 420, 430.

Each EPDCCH region 420 and 430 may be used for scheduling for different cells. For example, the EPDCCH in the EPDCCH region 420 carries scheduling information for the primary cell, while the EPDCCH in the EPDCCH region 430 carries scheduling information for the secondary cell.

When the EPDCCH is transmitted through the multiple antennas in the EPDCCH regions 420 and 430, the same precoding as for the EPDCCH may be applied to the DM RS within the EPDCCH regions 420 and 430.

While the PDCCH uses the CCE as a transmission resource unit, the transmission resource unit for EPCCH is referred to as ECCE (Enhanced Control Channel Element). The aggregation level (AL) may be defined as a resource unit used for monitoring the EPDCCH. For example, if one ECCE is the minimum resource for the EPDCCH, it may be defined as the aggregation level AL={1, 2, 4, 8, 16}.

Hereinafter, the EPDCCH search space may correspond to the EPDCCH region. In the EPDCCH search space, one or more EPDCCH candidates may be monitored for one or more aggregation levels.

Now, resource allocation for EPDCCH will be described.

The EPDCCH is transmitted using one or more ECCEs. The ECCE includes a plurality of Enhanced Resource Element Groups (EREGs). Depending on the subframe type and CP type according to the TDD (Time Division Duplex) DL-UL configuration, the ECCE may include 4 EREGs or 8 EREGs. For example, in a normal CP, an ECCE may include 4 EREGs, and an ECCE may include 8 EREGs in an extended CP.

A PRB (Physical Resource Block) pair refers to two PRBs having the same RB number in one subframe. The PRB pair refers to the first PRB of the first slot and the second PRB of the second slot in the same frequency region. In a normal CP, the PRB pair includes 12 subcarriers and 14 OFDM symbols, and therefore contains 168 resource elements (REs).

The EPDCCH search space may be composed of one PRB pair or a plurality of PRB pairs. One PRB pair includes 16 EREGs. Thus, if the ECCE contains four EREGs, then the PRB pair contains four ECCEs, while if the ECCE contains eight EREGs, the PRB pair contains two ECCEs.

Hereinafter, a synchronization signal (SS) will be described.

In the LTE/LTE-A system, the synchronization with the cell is achieved using the synchronization signal (SS) in the cell search procedure.

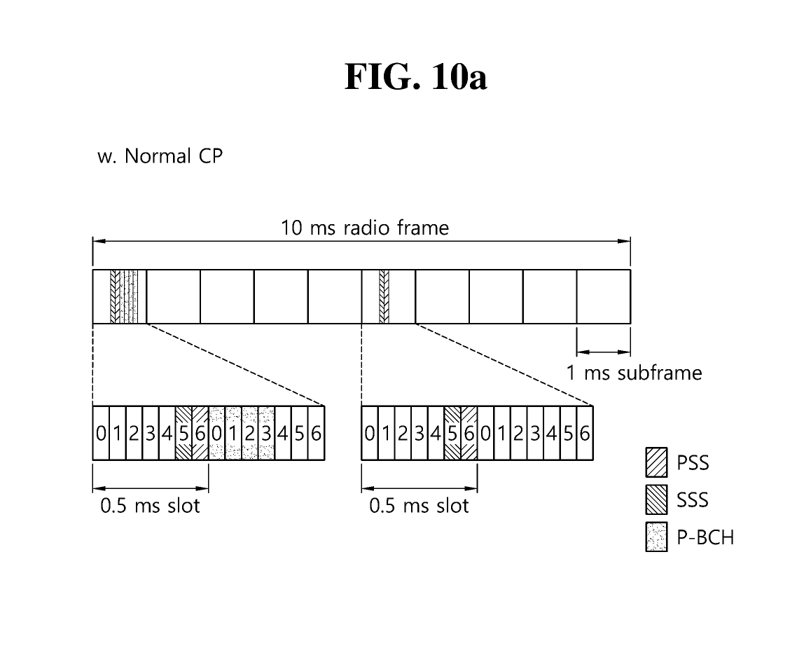

FIGS. 10A and 10B show frame structures for synchronization signal transmission in Normal CP (Normal CP) and Extended CP (Extended CP), respectively.

Referring to FIGS. 10A and 10B, in order to facilitate the inter-RAT measurement, a synchronization signal SS is generated in a second slot of a subframe 0 and a second slot of a subframe 5 respectively in consideration of a GSM frame length of 4.6 ms. The boundary for the corresponding radio frame may be detected via S-SS (Secondary Synchronization Signal).

P-SS (Primary Synchronization Signal) is transmitted using the last OFDM symbol of the corresponding slot. The S-SS is transmitted using an OFDM symbol immediately preceding the last OFDM symbol.

The synchronization signal (SS) may transmit a total of 504 physical cell IDs including a combination of 3 P-SSs and 168 S-SSs.

Further, the synchronization signal (SS) and the PBCH (Physical Broadcast Channel) are transmitted in six middle RBs in the system bandwidth. Thus, the UE may detect or decode the SS and PBCH regardless of the transmission bandwidth.

Hereinafter, the MTC will be described.

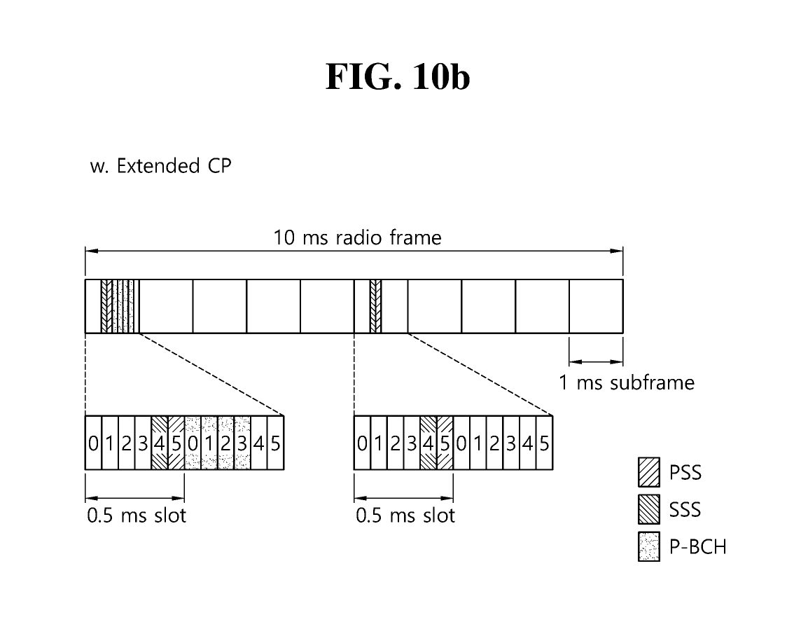

FIG. 11 illustrates an example of the machine type communication (MTC).

The machine type communication (MTC) represents information exchange through between MTC UE 100 through a base station 20 or information exchange between the MTC UE 100 and an MTC server 300 through the base station, which does not accompany human interaction.

The MTC UE 100 as a wireless device providing the MTC may be fixed or mobile.

The MTC server 300 is an entity which communicates with the MTC UE 100.

The MTC server 700 executes an MTC application and provides an MTC specific service to the MTC device.

The service provided through the MTC has discrimination from a service in communication in which human intervenes in the related art and includes various categories of services including tracking, metering, payment, a medical field service, remote control, and the like. In more detail, the service provided through the MTC may include electric meter reading, water level measurement, utilization of a monitoring camera, reporting of an inventory of a vending machine, and the like.

As peculiarities of the MTC device, since a transmission data amount is small and uplink/downlink data transmission/reception often occurs, it is efficient to decrease manufacturing cost of the MTC device and reduce battery consumption according to the low data transmission rate. The MTC device is characterized in that mobility is small, and as a result, the MTC device is characterized in that a channel environment is not almost changed.

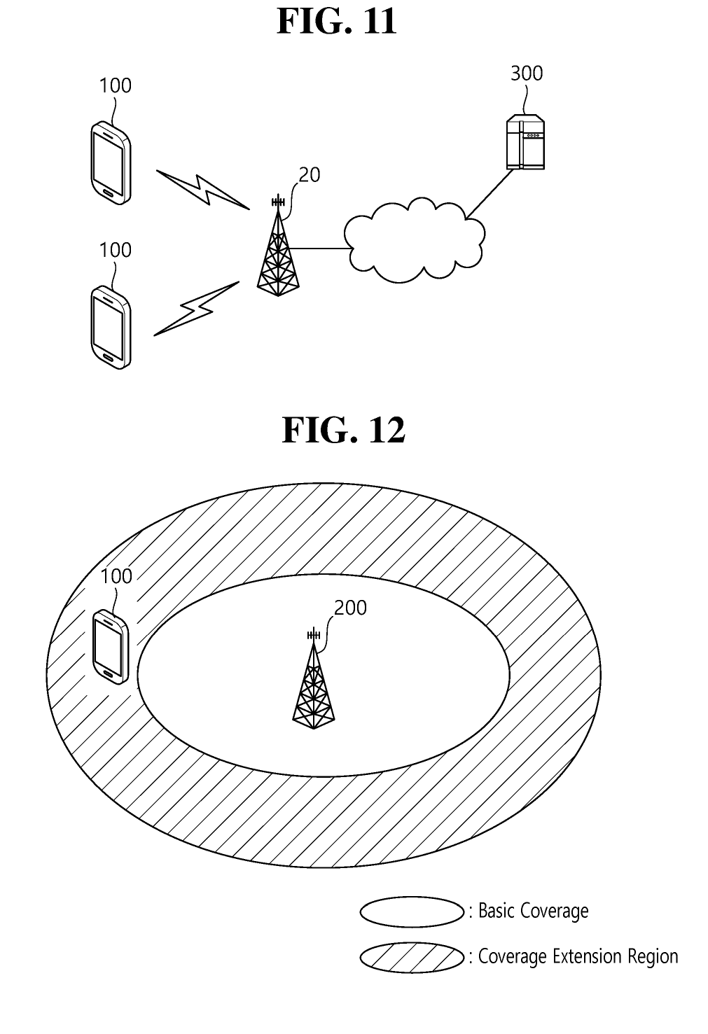

FIG. 12 illustrates an example of cell coverage extension or enhancement for an MTC UE.

In recent years, it is considered that cell coverage of the base station extends for the MTC UE 100 and various techniques for the cell coverage extension or enhancement are discussed.

However, in the case where the coverage of the cell extends or enhanced, when the base station transmits a downlink channel to the MTC UE 100 positioned in the coverage extension or enhancement area, the MTC UE 100 undergoes a difficulty in receiving the downlink channel.

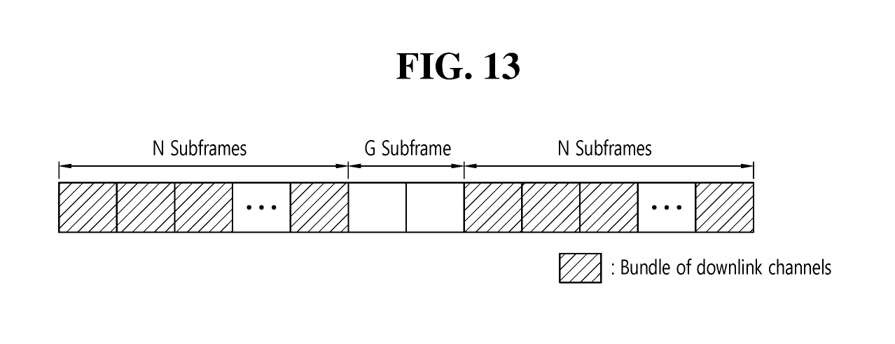

FIG. 13 is an exemplary diagram illustrating an example of bundle transmission.

Referring to FIG. 13, in order to solve the above-described problem, the base station 200 repeatedly transmits a downlink channel to a MTC UE 100 located in a coverage extended region or a coverage enhanced region on a plurality of subframes (for example, N subframes). The physical channels repeatedly transmitted on the plurality of subframes are called a bundle of channels.

Further, the MTC UE 100 can increase the decoding success rate by receiving the bundle of the downlink channels on a plurality of subframes and decoding some or all of the bundle.

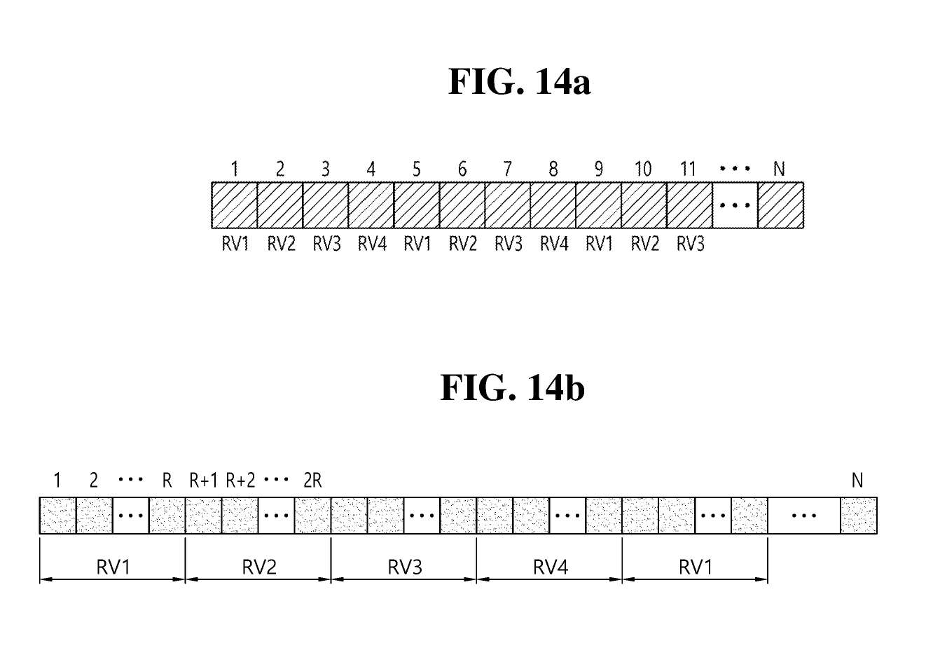

FIGS. 14A and 14B are illustrations showing some examples of RV (Redundancy Version) of the bundle transmission.

As shown in FIG. 14A, RV (Redundancy Version) values of a bundle of physical channels repeatedly transmitted on a plurality of subframes may be cyclically applied per each subframe.

Further, as shown in FIG. 14B, RV values of a bundle of physical channels repeatedly applied on a plurality of subframes may be cyclically applied per R subframes. At this time, the number R of subframes to which the same RV value is applied may be a predefined or fixed value or a value configured by the base station.

In this way, when the same RV value is applied to a plurality of subframes, data composed of the same bits are transmitted via the physical channels of the corresponding subframes. In this connection, combining all the data transmitted through the corresponding physical channel and receiving the combined data can improve the decoding success rate of the received data. To this end, in the DMRS (demodulation reference signal)-based data transmission environment, it is necessary to apply the same precoding to the plurality of subframe when transmitting data on the plurality of subframes.

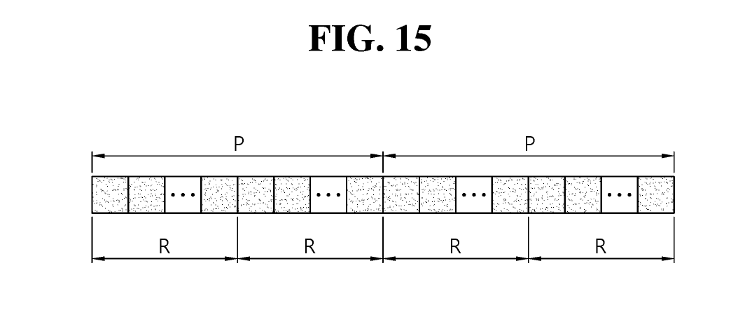

FIG. 15 is a diagram illustrating an example in which the same precoding is applied while a plurality of subframes are transmitted.

As shown in FIG. 15, the same precoding may be applied while P subframes are transmitted. In this case, the value of P may be a predefined fixed value or a value configured by the base station.

More specifically, by combining data transmitted on the subframes having the same RV value and performing modulation of the combined data in order to improve the data reception performance and obtain the precoding diversity effect, the value of the number P of subframes to which the same precoding is applied and the value of R which is the number of subframes to which the same RV value is applied may be configured to be equal.

When the value of P, which is the number of subframes to which the same precoding is applied, is not configured by the base station, but, only the value of R, the number of subframes to which the same RV value is applied, is configured for the UE, the UE may determine that the same precoding is applied to a bundle of consecutive subframes to which the same RV value is applied. Further, when a period by which different RV values are repeated or an interval between subframes to which the same RV value is applied again is defined as an RV cycling period, the UE may determine that the same procoding may be applied during one RV cycle period (or during a period corresponding to a multiple of the RV cycle period).

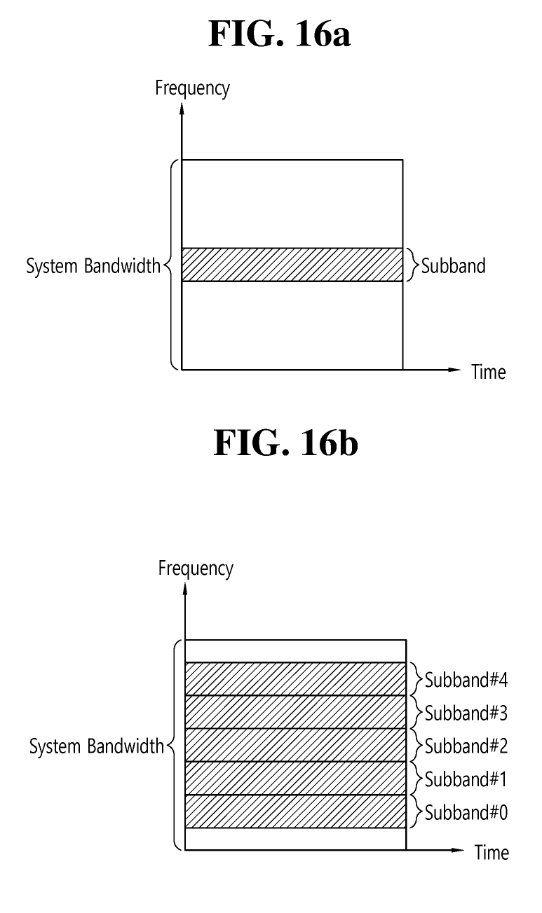

FIG. 16A and FIG. 16B are exemplary diagrams showing some examples of subbands in which the MTC UE operates.

As a measure for the low cost of the MTC UE, regardless of the system bandwidth of the cell, the MTC UE may only use the partial subband.

At this time, as shown in FIG. 16A, the region of the subband in which the MTC UE operates may be located in the central region of the system bandwidth of the cell. Further, for multiplexing within a subframe between MTC UEs, as shown in FIG. 16B, a plurality of subbands are arranged in one subframe, and a plurality of MTC UEs may use different subbands.

In this case, the MTC UE cannot normally receive the legacy PDCCH transmitted through the entire system band. Further, when a PDCCH for an MTC UE is transmitted in an OFDM symbol region where a legacy PDCCH is transmitted, a problem related to multiplexing with a PDCCH transmitted to another UE may occur. To solve this problem, it is necessary to introduce a control channel for the MTC UE which is transmitted in the subband in which the MTC UE operates. The legacy EPDCCH itself may be used as the downlink control channel for the MTC UE or a modification of a legacy PDCCH or an EPDCCH may be introduced as the control channel. For the convenience of explanation, the present disclosure defines the downlink control channel for the MTC UE as an M-PDCCH.

The MTC UE located in the coverage extended or enhanced region may transmit data channels such as PDSCH or PUSCH or control channels such as M-PDCCH, PUCCH or PHICH repeatedly on a plurality of subframes. However, when the same data is repeatedly transmitted over the plurality of subframes, the amount of data that can be transmitted using the same resource for a predetermined time or the number of MTC UEs using the same resource for the predetermined time may be greatly reduced.

<Disclosure of the Present Specification>

In order to improve the throughput of the system by multiplexing data with a limited number of resources by MTC UEs, orthogonal spreading codes may be applied to data transmitted repeatedly over a plurality of subframes, thereby multiplexing data for a plurality of MTC UEs. The present disclosure provides data transmission methods in which, when a PUSCH is repeatedly transmitted over multiple subframes, the methods includes multiplexing PUSCHs for multiple MTC UEs with the same resource using orthogonal spreading codes. Although the present disclosure is described with reference to transmission of the PUSCH to the MTC UE for convenience of explanation, it is obvious that the methods according to the present disclosure may be applied to transmission of other channels such as PDSCH, PUCCH, PHICH or M-PDCCH. Further, the methods proposed by the present disclosure are not limited to MTC UEs, but, it is clear that the methods proposed by the present disclosure may be applied to other UEs transmitting data or control channels on multiple subframes. Further, according to the present disclosure, orthogonal spreading codes may be equally applied to all OFDM symbols in a subframe. Alternatively, the orthogonal spreading code may be applied only to OFDM symbols using which data rather than DMRS are transmitted.

I. PUSCH Transmission Method 1 Using Orthogonal Spreading Codes

The MTC UE may apply orthogonal spreading codes of a length X to each subframe on on X subframes basis for a PUSCH repeatedly transmitted on a plurality of subframes.

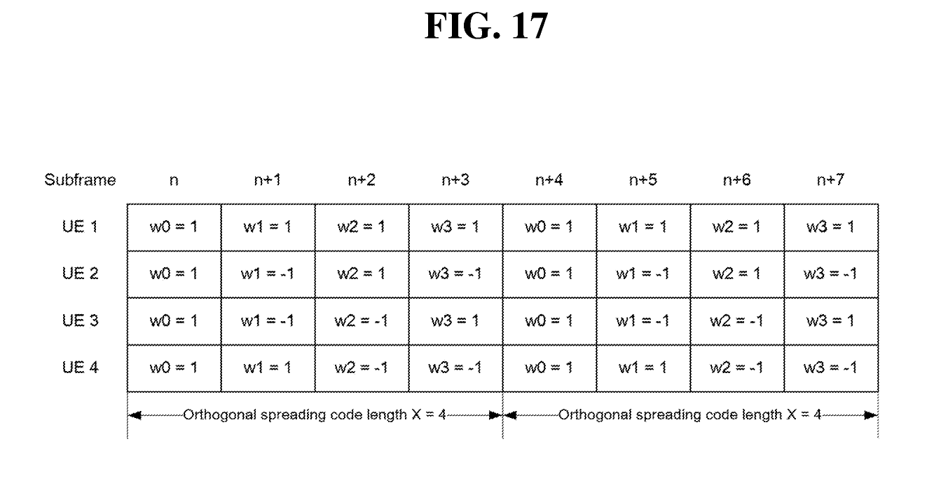

FIG. 17 shows an example in which orthogonal spreading codes are applied according to the PUSCH transmission method 1.

As shown in FIG. 17, the MTC UEs may apply orthogonal spreading codes of [w(0), w(1), w(2), w(3)] to each subframe on on X subframes basis. In this connection, applying the orthogonal spreading codes of the length X to each subframe on on X subframes basis may refer to multiplying each modulated symbol (for example, a complex-valued symbol from the modulation mapper) of the PUSCH transmitted on the subframe n+X by w(X) for subframe n, subframe n+1, . . . , subframe n+X−1, on X subframes basis. Alternatively, applying the orthogonal spreading codes of the length X to each subframe on on X subframes basis may refer to multiplying each modulated symbol (for example, a complex-valued symbol from the modulation mapper) of the PUSCH transmitted using each resource element (RE) of the subframe n+X by w(X) for subframe n, subframe n+1, . . . , subframe n+X−1, on X subframes basis.

Therefore, different MTC UEs may perform multiplexing of PUSCHs by transmitting PUSCHs using the same resource block (RB) by applying different orthogonal spreading codes.

Further, the MTC UEs apply orthogonal spreading codes of the length X to A×X subframes. In this case, it is also possible to apply w(x) to a bundle of A x-th subframes on A subframes basis.

When orthogonal spreading codes of length X are applied on X subframes basis, the following Tables 3 to 5 show examples of orthogonal spreading codes (i.e., orthogonal sequences) according to lengths X=2, 3, and 4 respectively.

TABLE 3

| Index | Orthogonal spreading codes [w(0), w(1)] when X = 2 |
|---|---|
| 0 | [1 1] |
| 1 | [1 −1] |

TABLE 4

| Index | Orthogonal spreading codes [w(0), w(1), w(2)] when X = 3 |
|---|---|
| 0 | [1 1 1] |
| 1 | [1 e^{j2Π/3} e^{j4Π/3}] |
| 2 | [1 e^{j4Π/3} e^{j2Π/3}] |

TABLE 5

| Index | Orthogonal spreading code [w(0), w(1), w(2), w(3)] when X = 4 |
|---|---|
| 0 | [+1 +1 +1 +1] |
| 1 | [+1 −1 +1 −1] |
| 2 | [+1 +1 −1 −1] |
| 3 | [+1 −1 −1 +1] |

When orthogonal spreading codes of length X are applied on an X subframes basis and multiple MTC UEs transmit PUSCHs via the same RB using applications of different orthogonal spreading codes, one MTC UE must transmit the same symbol for X subframes in order for the base station to distinguish between these multiplexed PUSCHs. To this end, when the PUSCHs are transmitted on a total of N_{PUSCH} subframes, the same RV (Redundancy Version) and scrambling code shall be applied during the X subframes to which orthogonal spreading codes of length X are applied, or during the N_{PUSCH} subframes to which the PUSCHs are transmitted.

When frequency hopping is applied on Y subframes basis at the time of transmission of the PUSCHs, the Y value may be equal to X of the subframes to which orthogonal spreading codes are applied, or may be a multiple of X. Hereinafter, for convenience of explanation, Y*X subframes to which orthogonal spreading codes of length X are applied are defined as a spreading subframe set.

More specifically, the orthogonal spreading codes may be applied to a PUSCH bundle transmitted on discontinuous subframes. For example, it is assumed that the PUSCHs are transmitted on subframe n, subframe n+1, subframe n+2, subframe n+4, subframe n+5, subframe n+6, and subframe n+7. It is assumed that the number of uplink subframes actually used in successive M subframes on M subframes basis (for example, M=4) is X. Further, it is assumed that the orthogonal spreading codes of length X are applied to M subframes. In this case, total subframes are divided into sets of M=4 subframes. The orthogonal spreading codes are applied in each set of M=4 subframes. Subframe n, subframe n+1 and subframe n+2 are actually used for PUSCH transmission among the subframe n, subframe n+1, subframe n+2 and subframe n+3. Thus, the orthogonal spreading code of length 3 is applied. Among subframe n+4, subframe n+5, subframe n+6, and subframe n+7, all of these 4 subframes are used for PUSCH transmission such that the orthogonal spreading codes of length 4 are applied.

For PUSCHs transmitted on up to M consecutive subframes, orthogonal spreading codes may be applied. For example, it is assumed that PUSCHs are transmitted on subframe n, subframe n+1, subframe n+3, subframe n+4, subframe n+5, subframe n+6, and subframe n+7. In this case, since the subframe n and the subframe n+1 are continuous, orthogonal spreading codes of length 2 may be applied thereto. Since subframe n+3, subframe n+4, subframe n+5, subframe n+6, subframe n+7 and subframe n+8 are continuous, orthogonal spreading codes of length 4 are applied to the subframe n+3, subframe n+4, subframe n+5, and subframe n+6. Then, the orthogonal spreading codes of length 2 may be applied to the subframe n+7 and subframe n+8 since the subframe n+7 and subframe n+8 are continuous.

Alternatively, the orthogonal spreading codes of length X may be applied, regardless of the number or location of the subframes actually used to transmit the PUSCH. That is, for example, orthogonal spreading codes of w(0), w(1), w(2), and w(3) may be applied to subframe n, subframe n+1, . . . , subframe n+X−1 respectively on X subframes basis. In addition, when PUSCHs are actually transmitted on subframe n, subframe n+1, and subframe n+3, orthogonal spreading codes of w(0), w(1), and w(2) may be applied to the subframe n, subframe n+1, and subframe n+3, respectively.

I-1. Method for Applying Orthogonal Spreading Codes in TDD Environment

According to the present disclosure, it is proposed to apply the orthogonal spreading codes of length X to X uplink consecutive subframes based on the PUSCH transmission method 1 including the scheme of applying the orthogonal spreading codes as described above.

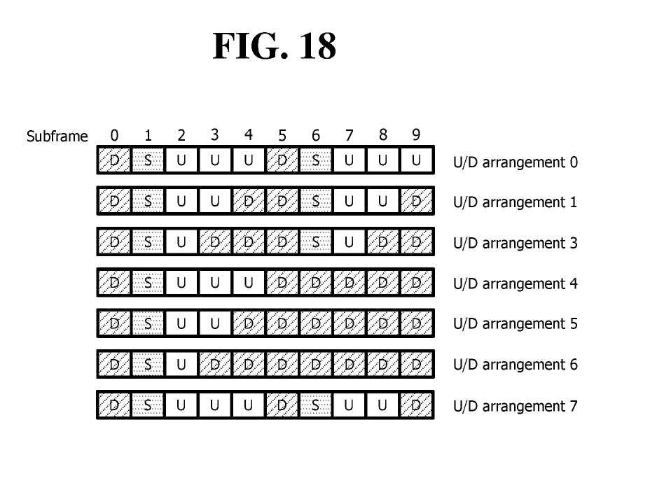

FIG. 18 shows the locations of the uplink, downlink or special subframe in the TDD environment.

Among the subframes shown in FIG. 18, U indicates the position of the uplink subframe, D indicates the position of the downlink subframe, and S indicates the position of the special subframe. Further, uplink subframes may be located continuously from a minimum of one to a maximum of three. For example, in the U/D arrangement 0, there are continuous uplink subframes corresponding to positions of subframe 2, subframe 3, subframe 4, and subframe 7, subframe 8, and subframe 9. In this case, orthogonal spreading codes of length 3 may be applied to successive uplink subframes. That is, in the U/D arrangement 0, orthogonal spreading codes w(0), w(1), and w(2) may be applied to the subframe 2, subframe 3, and subframe 4 respectively, while the orthogonal spreading codes of w(0), w(1) and w(2) may be applied to subframe 7, subframe 8 and subframe 9 respectively.

In U/D arrangements 2 and 5, there is no continuous uplink subframes. In this case, the orthogonal spreading codes may not be applied.

Further, in the U/D arrangement 6, there are continuous uplink subframes corresponding to positions of subframe 2, subframe 3, subframe 4, subframe 7 and subframe 8. In this case, the orthogonal spreading codes of length 3 are applied to subframe 2, subframe 3, and subframe 4 respectively. Further, orthogonal spreading codes of length 2 may be applied to the subframe 7, and subframe 9.

In particular, when only uplink subframes of X are actually used for transmission of PUSCH among M consecutive uplink subframes, the orthogonal spreading codes of length X may be applied to the X uplink subframes. For example, in the U/D arrangement 0, when, among the subframe 2, subframe 3, and subframe 4, the subframe 2 and subframe 4 are actually used for repeated transmission of the PUSCH, the orthogonal spreading codes of length 2 may be applied to the subframe 2 and subframe 4 respectively.

Further, among the M uplink subframes used to transmit the PUSCH, orthogonal spreading codes of length X may be applied to X consecutive uplink subframes. For example, in the U/D arrangement 0, if only subframe 3 and subframe 4 among subframe 1, subframe 2, subframe 3 and subframe 4 are actually used for repeated transmission of the PUSCH, orthogonal spreading codes of length 2 may be applied to subframe 3 and subframe 4, respectively. Alternatively, if only the subframe 2 and subframe 4 among subframe 1, subframe 2, subframe 3 and subframe 4 in the U/D arrangement 0 are actually used for repeated transmission of the PUSCH, an orthogonal spreading code of length 1 may be applied to subframe 2 and subframe 4. The application of the orthogonal spreading code of length 1 is the same as non-application of the orthogonal spreading code.

Further, regardless of the number or locations of the uplink subframes actually used to transmit the PUSCH, the length of the orthogonal spreading codes to be applied may be determined based on the number of consecutive uplink subframes. For example, in the U/D arrangement 0, orthogonal spreading codes of w(0), w(1) and w(2) may be applied to successive subframe 2, subframe 3 and subframe 4, respectively. Further, when only subframe 3 and subframe 4 are actually used for repetitive transmission of the PUSCH, orthogonal spreading codes of w(1) and w(2) may be applied to subframe 3 and subframe 4, respectively.

I-2. Shortened PUSCH

On the subframe used to transmit PUSCH and SRS (Sounding Reference Signal) together, the MTC UE does not transmit the PUSCH using the resource element (RE) used for transmitting the SRS, and, rather, the MTC UE transmits the PUSCH with rate-matching the PUSCH. Thus, the PUSCH transmitted using fewer resources (fewer OFDM symbols) due to the transmission of the SRS is called a shortened PUSCH. Let the subframe used for transmission of the shortened PUSCH due to the transmission of SRS be a shortened subframe.

When orthogonal spreading codes are applied to transmit the PUSCH, a shortened subframe may occur due to transmission of SRS among subframes to which the orthogonal spreading codes are applied. In this case, the data size (number of bits) of the PUSCH that may be transmitted on a general subframe and the data size (number of bits) of the PUSCH that may be transmitted on the shortened subframe are different. As a result, the base station cannot normally receive the multiplexed PUSCHs resulting from applying orthogonal spreading codes by a plurality of MTC UEs. Therefore, in order to maintain the resource element mapping (RE mapping) of PUSCH to be the same between subframes to which orthogonal spreading codes are applied, the following scheme may be considered.

Scheme 1: SRS may be configured so that only non-shortened PUSCHs or shortened PUSCHs are transmitted on subframes to which orthogonal spreading codes are applied (that is, on subframes constituting one spreading subframe set).

Scheme 2: On the subframes (that is, the subframes constituting one spreading subframe set) to which orthogonal spreading codes are applied, the last OFDM symbol is not used for PUSCH transmission, and transmission of the PUSCH may be rate-matched using the corresponding resource.

Scheme 3: On the subframes (that is, the subframes constituting one spreading subframe set) to which orthogonal spreading codes are applied, the last OFDM symbol is not used for PUSCH transmission, and transmission of the PUSCH may be punctured using the corresponding resource.

Scheme 4: On the subframes (that is, the subframes constituting one spreading subframe set) to which orthogonal spreading codes are applied, transmission of the PUSCH may be punctured using a resource (resource element region) used for SRS transmission, and SRS transmission may be performed.

Scheme 5: On the subframes (that is, the subframes constituting one spreading subframe set) to which orthogonal spreading codes are applied, transmission of the PUSCH may be punctured using the last OFDM symbol on the subframe (i.e., a shortened subframe) used for transmission of the SRS.

I-3. Early Termination of PUSCH Transmission

In the process of repeatedly transmitting PUSCH on multiple subframes, the base station has successfully received the PUSCH, and thus the base station may send a signal to the multiple MTC UEs to stop transmission of the PUSCH. Thus, since the base station has successfully received the PUSCH being repeatedly transmitted, the base station is instructing to stop transmission of the PUSCH using a signal which is referred to as an early transmission-termination signal. This early transmission-termination signal may be transmitted via PHICH or M-PDCCH (specifically, uplink grant). Further, upon receipt of the early transmission-termination signal, the MTC UEs may repeatedly terminate the transmission of the PUSCH being repeatedly transmitted.

In this case, even when the MTC UE receives the early transmission-termination signal, transmission of PUSCH may be stopped only after the MTC UE completes the transmissions on the spreading subframe set on which the PUSCH transmission is on-going at the time of receiving the early transmission-termination signal (specifically, the position of the subframe used to receive the signal). That is, even though the MTC UE receives the early transmission-termination signal from the base station, the transmission of the PUSCH is maintained until the transmission on the subframe to which the same orthogonal spreading code is applied is terminated. Then, when transmission on the subframe to the same orthogonal spreading code is applied is terminated, transmission of the PUSCH may be stopped. This is because only when the base station receives all of the PUSCHs on the spreading subframe set, the PUSCHs for a plurality of MTC UEs multiplexed on the corresponding subframe may be distinguished by the base station.

II. PUSCH Transmission Method 2 Including Application of Orthogonal Spreading Codes

When the MTC UE transmits PUSCHs on multiple subframes, the MTC UE may apply the orthogonal spreading codes on one subframe.

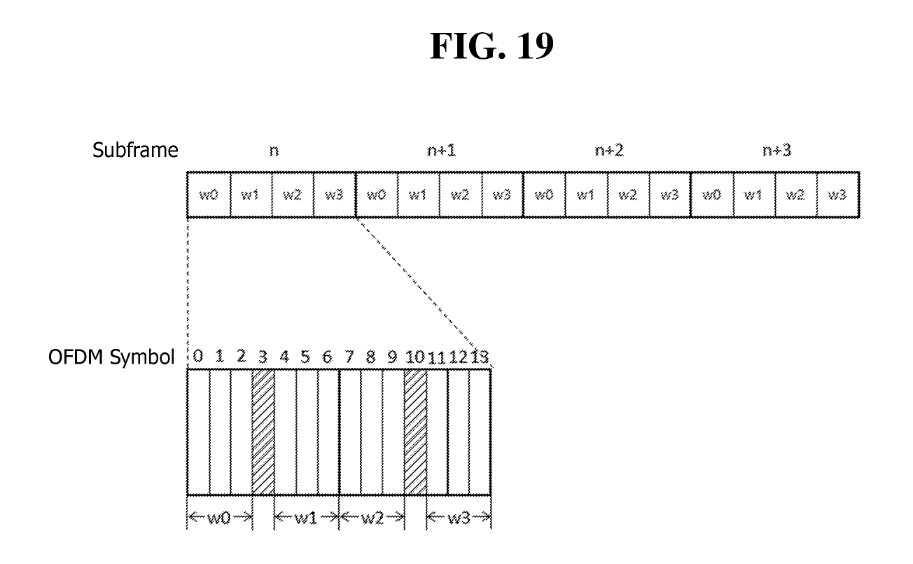

FIG. 19 shows an example in which the orthogonal spreading codes are applied according to the PUSCH transmission method 2.

As shown in FIG. 19, the MTC UE may divide the OFDM symbols used for PUSCH transmission on the subframe into sets of X symbols and apply orthogonal spreading codes on the subframe. For example, if X=4, W(0) is applied to OFDM symbols 0, 1 and 2, W(1) may be applied to OFDM symbols 4, 5, and 6, W(2) may be applied to OFDM symbols 7, 8, and 9, W(3) may be applied to the OFDM symbols 11, 12, and 13. In this connection, applying W(x) to a specific OFDM symbol may mean multiplying, by W(x), each modulated symbol of the PUSCH transmitted using the corresponding OFDM symbol (e.g., the complex symbol passed through the modulation mapper).

Further, applying orthogonal spreading codes of length 4 to 12 OFDM symbols in one subframe on 3 OFDM symbols basis may include multiplying, by W(0), each modulated symbol of the PUSCH transmitted using the corresponding OFDM symbol for the OFDM symbols 0, 1, and 2; multiplying, by W(1), each modulated symbol of the PUSCH transmitted using the corresponding OFDM symbol for the OFDM symbols 4, 5, and 6; multiplying, by W(2), each modulated symbol of the PUSCH transmitted using the corresponding OFDM symbol for the OFDM symbols 7, 8, and 9; and multiplying, by W(3), each modulated symbol of the PUSCH transmitted using the corresponding OFDM symbol for the OFDM symbols 11, 12, and 13. Alternatively, applying orthogonal spreading codes of length 4 to 12 OFDM symbols in one subframe on 3 OFDM symbols basis may include multiplying, by W(0), each complex-valued symbol of the PUSCH transmitted using each resource element (RE) of the corresponding OFDM symbol for the OFDM symbols 0, 1, and 2; multiplying, by W(1), each complex-valued symbol of the PUSCH transmitted using each resource element (RE) of the corresponding OFDM symbol for the OFDM symbols 4, 5, and 6; multiplying, by W(2), each complex-valued symbol of the PUSCH transmitted using each resource element (RE) of the corresponding OFDM symbol for the OFDM symbols 7, 8, and 9; and multiplying, by W(3), each complex-valued symbol of the PUSCH transmitted using each resource element (RE) of the corresponding OFDM symbol for the OFDM symbols 11, 12, and 13.

In this case, for A symbols (for example, A=12) used for PUSCH transmission on one subframe, the number of OFDM symbols to which the orthogonal spreading codes of length X (W(0), W(1), . . . , W(X)) are applied may be A/X. Hereinafter, for convenience of description, OFDM symbols to which the same W(x) is applied are defined as a symbol group.

When orthogonal spreading codes of length X (W(0), W(1), . . . , W(X)) are applied, the number of OFDM symbols constituting the symbol group to which the same W(x) is applied may be A/X. The number of symbol groups in one subframe may be X. In this connection, the same data is repeatedly transmitted in X symbol groups. When k is 0, 1, or 2, the modulated symbol transmitted using OFDM symbols k, k+4, k+7, and k+11 may define the same symbol. In this case, one transport block is rate-matched to be adapted to the amount of data that may be transmitted using a total of 3×4 OFDM symbols. Such a block may be divided into 4 ¼ sub-blocks and the divided sub-blocks may be transmitted on four subframes respectively. Specifically, the first quarter of data is transmitted on subframe n, the second ¼ portion is transmitted on subframe n+1, the third quarter portion is transmitted on subframe n+2, and the last quarter is transmitted on subframe n+3. In this case, within each subframe, ¼ data is repeated four times in total. The first repeated data portion is transmitted using OFDM symbols 0, 1 and 2; the second repeated data portion is transmitted using OFDM symbols 4, 5 and 6; the third repeated data portion is transmitted through OFDM symbols 7, 8 and 9; and the fourth repeated data portion is transmitted using OFDM symbols 11, 12, and 13.

Alternatively, some subframes of the four subframes may not be used for transmission of the PUSCH. It is assumed that the number of subframes that may be used to transmit the PUSCH among the four subframes is M. In this case, one transport block is rate-matched to be adapted to the amount of data that may be transmitted using a total of 3×M OFDM symbols. Such a block may be divided into M 1/M sub-blocks and the divided sub-blocks may be transmitted on M subframes respectively. The specific process in which the PUSCH is transmitted on each subframe is the same as the above-described process.

III. Configuration of Orthogonal Spreading Codes

The MTC UE may determine the indexes of the orthogonal spreading codes to be applied to transmission of the PUSCH according to the following scheme or a combination of the following schemes.

Scheme 1: The MTC UE may configure the indexes of orthogonal spreading codes based on DCI (Downlink Control Information).

Scheme 2: The MTC UE may configure the indexes of the orthogonal spreading codes based on the identifier of the MTC UE (e.g., Cell-Radio Network Temporary Identifier (C-RNTI)).

Scheme 3: The MTC UE may configure the indexes of the orthogonal spreading codes based on the value of the DCI's “cyclic shift for DMRS and OCC (Orthogonal Cover Code) Index” field. For example, when the value of the “Cyclic Shift for DMRS and OCC Index” field is k, the indexes of orthogonal spreading codes of length X may be k mod X. Alternatively, when the value of the “Cyclic Shift for DMRS and OCC Index” field is k, the indices of orthogonal spreading codes of the length X may be floor (k/X).

Scheme 4: The MTC UE may configure the indexes of orthogonal spreading codes based on coverage extended level or coverage enhancement level. For example, the MTC UE can determine the indexes of orthogonal spreading codes to be applied to the PUSCH transmission based on the coverage extended level determined by performing Radio Resource Management (RRM). Further, the MTC UE may differentiate the orthogonal spreading codes to be applied to the PUSCH transmission, thereby notifying the base station of the report value of the coverage extended level according to the RRM.

Scheme 5: The MTC UE may configure the indexes of the orthogonal spreading codes based on the repetition level of the PUSCH transmission.

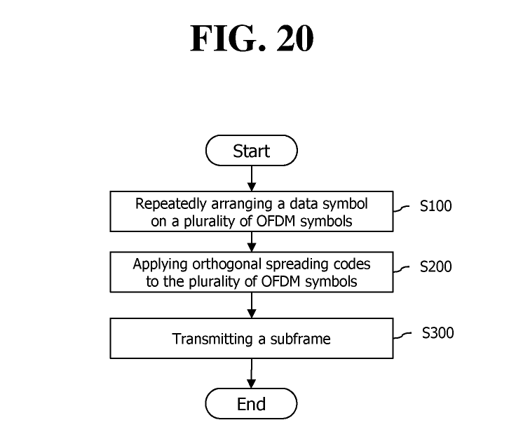

FIG. 20 is a flowchart showing a PUSCH transmission method using application of orthogonal spreading codes according to the present disclosure.

Referring to FIG. 20, the MTC UE repeatedly arranges a plurality of data symbols constituting a PUSCH on a symbol unit basis (S100). More specifically, the MTC UE may repeatedly arrange each data symbol constituting the PUSCH on a plurality OFDM symbols on a symbol basis.

The MTC UE applies the orthogonal spreading codes to a plurality of OFDM symbols on which each data symbol is repeatedly arranged (S200). For example, it may be assumed that four data symbols are repeatedly arranged on four OFDM symbols, and the orthogonal spreading codes of length 4 are applied thereto. In this case, a first element W(0) of the orthogonal spreading codes is applied to a plurality of first OFDM symbols, a second element W(1) of the orthogonal spreading codes is applied to a plurality of second OFDM symbols, a third element W(2) of the orthogonal spreading codes is applied to a plurality of third OFDM symbols, and a fourth element W(3) of the orthogonal spreading codes is applied to a plurality of fourth OFDM symbols.

In this connection, applying the element of the orthogonal spreading codes may be done by multiplying the repeatedly arranged data symbols on a number of OFDM symbols by the element of the orthogonal spreading codes. Alternatively, applying the orthogonal spreading code element may be performed by multiplying, by the element of the orthogonal spreading code, a complex-valued symbol of a data symbol to be transmitted using resource elements (REs) of a plurality of OFDM symbols.

OFDM symbols to which the orthogonal spreading codes are applied may be composed of the same number of OFDM symbols as a number resulting from division of the total number A of OFDM symbols used for transmitting PUSCH on the uplink subframe by the length X of orthogonal spreading codes.

When the orthogonal spreading codes are applied by the MTC UE, the MTC UE may determine the indexes of the orthogonal spreading codes based on the coverage extended level obtained by performing Radio Resource Management (RRM). Alternatively, when the orthogonal spreading codes are applied by the MTC UE, the MTC UE may determine the indexes of the orthogonal spreading codes based on the repetition level at which the data symbols are repeatedly placed on the OFDM symbols.

Then, the MTC UE may transmit to the base station the uplink subframe including OFDM symbols to which the orthogonal spreading codes are applied (S300). In this case, when a signal indicating stopping the transmission of the PUSCH is received from the base station, the MTC UE may stop transmission of the PUSCH only after all OFDM symbols to which the same element of orthogonal spreading code is applied are transmitted.

The embodiments of the present invention as described above may be implemented using various means. For example, the embodiments of the present invention may be implemented by hardware, firmware, software, or a combination thereof. More specifically, the description will be made with reference to the drawings.

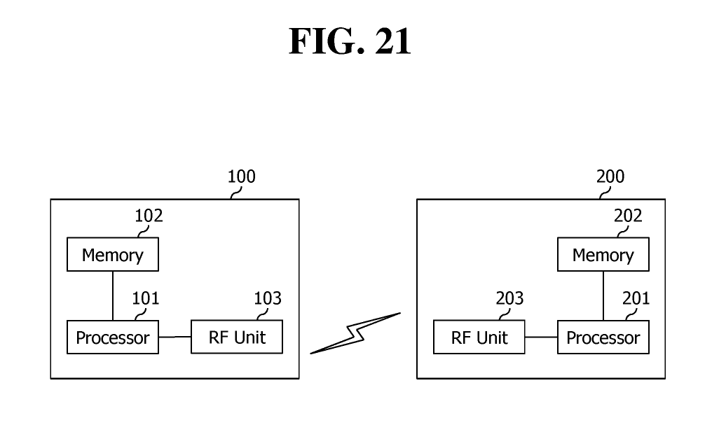

FIG. 21 is a block diagram showing a wireless communication system which implements the present invention.

Referring to FIG. 21, the base station 200 includes a processor 201, a memory 202, and a radio frequency RF unit 203. The memory 202 is connected to the processor 201 to store various information for driving the processor 201. The RF unit 203 is connected to the processor 201 to transmit and/receive a wireless signal. The processor 201 implements a suggested function, procedure, and/or method. An operation of the base station 200 according to the above embodiment may be implemented by the processor 201.

The MTC UE 100 includes a processor 101, a memory 102, and an RF unit 103. The memory 102 is connected to the processor 101 to store various information for driving the processor 101. The RF unit 103 is connected to the processor 101 to transmit and/receive a wireless signal. The processor 101 implements a suggested function, procedure, and/or method.

The processor may include an application-specific integrated circuit (ASIC), another chipset, a logic circuit, and/or a data processor. A memory may include read-only memory (ROM), random access memory (RAM), a flash memory, a memory card, a storage medium, and/or other storage devices. An RF unit may include a baseband circuit to process an RF signal. When the embodiment is implemented, the above scheme may be implemented by a module procedure, function, and the like to perform the above function. The module is stored in the memory and may be implemented by the processor. The memory may be located inside or outside the processor, and may be connected to the processor through various known means.

In the above exemplary system, although methods are described based on a flowchart including a series of steps or blocks, the present invention is limited to an order of the steps. Some steps may be generated in the order different from or simultaneously with the above other steps. Further, it is well known to those skilled in the art that the steps included in the flowchart are not exclusive but include other steps or one or more steps in the flowchart may be eliminated without exerting an influence on a scope of the present invention.

What is claimed is:

1. A method for transmitting an uplink data channel in a wireless communication system, the method comprising:
repeatedly arranging a first data symbol of a plurality of data symbols on a plurality of first OFDM symbols, wherein the plurality of data symbols constitutes the uplink data channel;
repeatedly arranging a second data symbol of the plurality of data symbols on a plurality of second OFDM symbols;
applying a first element of orthogonal spreading codes to the plurality of first OFDM symbols;
applying a second element of the orthogonal spreading codes to the plurality of second OFDM symbols; and
transmitting a first uplink subframe including the plurality of first and second OFDM symbols to a base station.

2. The method of claim 1, wherein the orthogonal spreading codes have a length corresponding to a number of groups of the OFDM symbols repeatedly arranged in the first uplink subframe.

3. The method of claim 2, wherein applying the first element comprises multiplying, by the first element, the first data symbol repeatedly arranged on the plurality of first OFDM symbols.

4. The method of claim 2, wherein applying the first element comprises multiplying, by the first element, a complex-valued symbol of the first data symbol transmitted using resource elements of the plurality of first OFDM symbols.

5. The method of claim 1, wherein a number of the first OFDM symbols corresponds to a number resulting from a division of a total number of OFDM symbols used for transmitting the uplink data channel in the first uplink subframe by a length of the orthogonal spreading codes.

6. The method of claim 1, wherein applying the first element includes determining indexes of the orthogonal spreading codes to be applied to the first uplink subframe based on a coverage enhancement level obtained by performing Radio Resource Management (RRM).

7. The method of claim 1, wherein applying the first element include determining indexes of the orthogonal spreading codes to be applied to the first uplink subframe based on a repetition level at which the first data symbol is repeatedly arranged on the first OFDM symbols.

8. The method of claim 1, wherein transmitting the first uplink subframe to the base station comprises:
receiving a signal indicating stopping of transmission of the uplink data channel from the base station; and
stopping the transmission of the uplink data channel only after all of OFDM symbols to which the same element of the orthogonal spreading codes is applied have been transmitted to the base station.

9. A wireless device for transmitting an uplink data channel in a wireless communication system, the device comprising a radio frequency unit and a processor coupled to the unit, wherein the processor is configured for:
repeatedly arranging a first data symbol of a plurality of data symbols on a plurality of first OFDM symbols, wherein the plurality of data symbols constitutes the uplink data channel;
repeatedly arranging a second data symbol of the plurality of data symbols on a plurality of second OFDM symbols;
applying a first element of orthogonal spreading codes to the plurality of first OFDM symbols;
applying a second element of the orthogonal spreading codes to the plurality of second OFDM symbols; and
controlling the unit to transmit a first uplink subframe including the plurality of first and second OFDM symbols to a base station.

10. The device of claim 9, wherein the orthogonal spreading codes have a length corresponding to a number of groups of the OFDM symbols repeatedly arranged in the first uplink subframe.

11. The device of claim 9, wherein a number of the first OFDM symbols corresponds to a number resulting from a division of a total number of OFDM symbols used for transmitting the uplink data channel in the first uplink subframe by a length of the orthogonal spreading codes.

12. The device of claim 9, wherein the processor configured for applying the first element is further configured for determining indexes of the orthogonal spreading codes to be applied to the first uplink subframe based on a coverage enhancement level obtained by performing Radio Resource Management (RRM).

13. The device of claim 9, wherein the processor configured for applying the first element is further configured for determining indexes of the orthogonal spreading codes to be applied to the first uplink subframe based on a repetition level at which the first data symbol is repeatedly arranged on the first OFDM symbols.

14. The device of claim 9, wherein the processor is further configured to control the unit to receive a signal indicating stopping of transmission of the uplink data channel from the base station, and to stop the transmission of the uplink data channel only after all of OFDM symbols to which the same element of the orthogonal spreading codes is applied have been transmitted to the base station.
